(19) United States
(12) Patent Application Publication
(10) Pub. No.: US 2025/0042754 A1
(43) Pub. Date: Feb. 6, 2025

(54) METHOD FOR PREPARING LITHIUM BIS(FLUOROSULFONYL)IMIDE

(71) Applicant: ARKEMA FRANCE, Colombes (FR)

(72) Inventors: Sébastien LOGETTE, Pierre-Benite Cedex (FR); Julien JOUANNEAU, Pierre-Benite Cedex (FR); Jean-Luc COUTURIER, Pierre-Benite Cedex (FR)

(73) Assignee: ARKEMA FRANCE, Colombes (FR)

(21) Appl. No.: 18/719,367

(22) PCT Filed: Dec. 1, 2022
(86) PCT No.: PCT/FR2022/052214

§ 371 Date: Jun. 13, 2024

(30) Foreign Application Priority Data
Dec. 16, 2021 (FR) FR2113700

(51) Int. Cl. C01D 15/00; H01M 10/0561

(52) U.S. Cl. CPC C01D 15/00; H01M 10/0561

(57) ABSTRACT

The present invention relates to a process for preparing lithium bis(fluorosulfonyl)imide, comprising the following steps of: contacting of bis(fluorosulfonyl)imide with a lithium base in a solvent selected from carbonates, ethers and nitriles, to obtain a mixture comprising lithium bis(fluorosulfonyl)imide and water; diafiltration of the mixture on a nanofiltration membrane so as to obtain, firstly, a concentrate enriched in lithium bis(fluorosulfonyl)imide and depleted in water and, secondly, a permeate depleted in lithium bis(fluorosulfonyl)imide and enriched in water. The present invention also relates to a process for preparing an Li-ion battery electrolyte.

### FIELD OF THE INVENTION

The present invention relates to a process for preparing lithium bis(fluorosulfonyl)imide, comprising a step of diafiltration on a nanofiltration membrane.

### TECHNICAL BACKGROUND

By virtue of their very low basicity, anions of sulfonylimide type are increasingly used in the field of energy storage in the form of inorganic salts in batteries, or of organic salts in supercapacitors or in the field of ionic liquids. Since the battery market is in full expansion and reduction of battery manufacturing costs has become a major challenge, an inexpensive large-scale process for synthesizing anions of this type is necessary.

In the specific field of Li-ion batteries, the salt that is currently the most widely used is LiPF₆, but this salt has many drawbacks such as limited thermal stability, sensitivity to hydrolysis and thus lower safety of the battery. Recently, new salts bearing the FSO₂-group have been studied and have demonstrated many advantages, such as better ion conductivity and resistance to hydrolysis. One of these salts, LiFSI (LiN(FSO₂)₂), has shown highly advantageous properties which make it a good candidate for replacing LiPF₆.

The majority of the processes for preparing imide salts containing a fluorosulfonyl group comprise numerous steps, the consequence of which is the formation of byproducts which have physical properties such that their removal may prove to be complex and/or may necessitate expensive purification steps. In addition, following the lithiation reaction to obtain the desired salt, a significant amount of water may be present in the solution comprising the imide salt. It is important to be able to reduce or even eliminate this amount of water.

The dehydration of organic solvents is an energy-consuming process. Distillation and other thermal separation methods represent 80% of the energy consumed for industrial separations, which demonstrates the need for more efficient separation.

Document WO 2015/004236 relates to a process for producing a dehydrated liquid mixture intended to be used as solvent for conductive salts (for example LiPF₆), in which the water content is reduced, proceeding from a liquid starting mixture comprising one, two, three or more organic carbonates in a total amount of 90% by weight or more, based on the total amount of the liquid starting mixture, and one, two or more compounds selected from the group consisting of acids with a pka of less than 4 and precursors that release acids with a pKa of less than 4 into the liquid starting mixture by hydrolysis.

Document FR 3089214 relates to a process for preparing imide salt containing a fluorosulfonyl group, the process comprising a step b) comprising a step of fluorination with anhydrous HF in the presence of at least one water-immiscible organic solvent; a step comprising the reaction of the composition obtained in the preceding step with an aqueous composition comprising at least one lithiated base.

Document US 2012/0141868 relates to a zeolite making possible a dehydration treatment of a non-aqueous electrolytic solution without posing the problem of elution of the sodium from the zeolite during the dehydration of a non-aqueous electrolytic solution for a lithium battery using a zeolite.

Document US 2020/0148633 relates to a process for preparing hydrogen bis(fluorosulfonyl)imide, comprising contacting sulfonyl fluoride with hexamethyldisilazane in an organic solvent. This document also relates to a process for preparing lithium bis(fluorosulfonyl)imide (LiFSI) by contacting hydrogen bis(fluorosulfonyl)imide with a lithium compound.

Document JP 2002001107 relates to a zeolite of crystalline faujasite type with a low silica content for treating a non-aqueous electrolyte, and to a process for producing the non-aqueous electrolyte using the zeolite.

There is therefore a real need to provide a process for preparing imide salts containing a fluorosulfonyl group, in particular lithium bis(fluorosulfonyl)imide, which makes it possible to reduce the energy consumption and also the amount of solvent used during the process, compared to existing techniques. In addition, there is a need to provide a process for preparing imide salts containing a fluorosulfonyl group, in particular lithium bis(fluorosulfonyl)imide, which makes it possible not only to avoid lithiation by toxic compounds such as lithium fluoride, but also to reduce the purification steps of the process.

### SUMMARY OF THE INVENTION

The invention relates firstly to a process for preparing lithium bis(fluorosulfonyl)imide, comprising the following steps of:
contacting of bis(fluorosulfonyl)imide with a lithium base in a solvent selected from carbonates, ethers and nitriles, to obtain a mixture comprising lithium bis(fluorosulfonyl)imide and water;
diafiltration of the mixture on a nanofiltration membrane so as to obtain, firstly, a concentrate enriched in lithium bis(fluorosulfonyl)imide and depleted in water and, secondly, a permeate depleted in lithium bis(fluorosulfonyl)imide and enriched in water.

According to certain embodiments, the solvent is a carbonate, preferably selected from dimethyl carbonate, methyl ethyl carbonate, diethyl carbonate, ethylene carbonate, propylene carbonate, butylene carbonate, diphenyl carbonate, methyl phenyl carbonate, dipropyl carbonate, methyl propyl carbonate, ethyl propyl carbonate, vinylene carbonate, fluoroethylene carbonate, trifluoropropylene carbonate, or mixtures thereof.

According to certain embodiments, the lithium base is selected from lithium hydroxide, lithium carbonate, and mixtures thereof.

According to certain embodiments, the nanofiltration membrane has a cutoff threshold of 80 to 250 dalton, preferably 100 to 200 dalton, and more preferably 120 to 180 dalton.

According to certain embodiments, the process comprises a step of pervaporation between the step of contacting bis(fluorosulfonyl)imide with a lithium base and the diafiltration step.

According to certain embodiments, the process comprises a step of azeotropic distillation between the step of contacting bis(fluorosulfonyl)imide with a lithium base and the diafiltration step.

According to certain embodiments, the concentrate enriched in lithium bis(fluorosulfonyl)imide and depleted in water comprises a content of water of equal to or less than 100 ppm, preferably equal to or less than 50 ppm, and more preferably equal to or less than 20 ppm, relative to the weight of the concentrate.

According to certain embodiments, solvent is added during the diafiltration step to the concentrate, the solvent preferably being the same as the solvent used in the step of contacting bis(fluorosulfonyl)imide with a lithium base.

According to certain embodiments, the diafiltration step is effected at a pressure from 1 to 60 bar.

The invention also relates to a process for preparing an Li-ion battery electrolyte, comprising:
preparing bis(fluorosulfonyl)imide as described above;
preparing an electrolyte comprising lithium bis(fluorosulfonyl)imide.

The present invention makes it possible to meet the need expressed above. More particularly, it provides a process for preparing lithium bis(fluorosulfonyl)imide, which makes it possible to reduce the energy consumption and also the amount of solvent used during the process, compared to existing techniques. In addition, the present invention also provides a process for preparing lithium bis(fluorosulfonyl)imide, which makes it possible not only to avoid lithiation by toxic compounds such as lithium fluoride, but also to reduce the purification steps of the process.

This is accomplished by means of the process of the present invention. More particularly, this process comprises a first step of contacting of bis(fluorosulfonyl)imide with a lithium base (capable of generating water after reaction thereof with the bis(fluorosulfonyl)imide) in a solvent selected from carbonates, ethers and nitriles, to form a mixture comprising the lithium bis(fluorosulfonyl)imide salt and water. The use of such a lithium base and the fact that the water can efficiently subsequently be removed makes it possible to avoid the use of toxic lithium salts.

Next, the step of diafiltration on a nanofiltration membrane makes it possible to efficiently remove the amount of water remaining without using methods that increase the energy consumption of the process or the consumption of solvent.

Lastly, during this diafiltration step, various impurities present in the mixture obtained after the step of contacting of bis(fluorosulfonyl)imide with the lithium base can also be eliminated, which makes it possible to reduce or even avoid additional purification steps.

### DETAILED DESCRIPTION

The invention is now described in more detail and in a non-limiting way in the description which follows.

### Lithium Battery

A lithium battery comprises at least one electrochemical cell, and preferably a plurality of electrochemical cells. Each electrochemical cell comprises a negative electrode, a positive electrode and an electrolyte interposed between the negative electrode and the positive electrode.

Each electrochemical cell can also comprise a separator, in which the electrolyte is impregnated.

The electrochemical cells can be assembled in series and/or in parallel in the battery.

The term “negative electrode” is understood to mean the electrode which acts as anode when the battery delivers current (that is to say, when it is in the process of discharging) and which acts as cathode when the battery is in the process of charging.

The negative electrode typically comprises an electrochemically active material, optionally an electronically conductive material, and optionally a binder.

The term “positive electrode” is understood to mean the electrode which acts as cathode when the battery delivers current (that is to say, when it is in the process of discharging) and which acts as anode when the battery is in the process of charging.

The positive electrode typically comprises an electrochemically active material, optionally an electronically conductive material, and optionally a binder.

The term “electrochemically active material” is understood to mean a material capable of reversibly inserting ions.

The term “electronically conductive material” is understood to mean a material that is capable of conducting electrons.

The negative electrode of the electrochemical cell can in particular comprise, as electrochemically active material, metallic lithium. This metallic lithium can be in essentially pure form or in the form of an alloy. Mention may be made, for example, among the lithium-based alloys capable of being used, of lithium-aluminum alloys, lithium-silica alloys, lithium-tin alloys, Li—Zn, Li₃Bi, Li₃Cd and Li₃SB. Mixtures of the above materials may also be used.

The negative electrode can be in the form of a film or a rod. An example of negative electrode can comprise an active lithium film prepared by rolling a strip of lithium between rollers.

The positive electrode comprises an electrochemically active material, preferably of the oxide type, and preferably selected from manganese dioxide (MnO₂), iron oxide, copper oxide, nickel oxide, lithium/manganese composite oxides (for example LiₓMn₂O₄ or LiₓMnO₂), lithium/nickel composite oxides (for example LiₓNiO₂), lithium/cobalt composite oxides (for example LiₓCoO₂), lithium/nickel/cobalt composite oxides (for example LiNi_{1-y}Co_{y}O₂), lithium/nickel/cobalt/manganese composite oxides (for example LiNiₓMn_{y}Co_{z}O₂ with x+y+Z=1), lithium-enriched lithium/nickel/cobalt/manganese composite oxides (for example Li₁₊ₓ(NiₓMn_{y}Co_{z})₁₋ₓO₂), lithium/transition metal composite oxides, lithium/manganese/nickel composite oxides of spinel structure (for example LiₓMn_{2-y}Ni_{y}O₄), vanadium oxides, and mixtures thereof.

Preferably, the positive electrode comprises an electrochemically active material which is a lithium/nickel/manganese/cobalt composite oxide having a high nickel content (LiNiₓMn_{y}Co_{z}O₂ with x+y+z=1, abbreviated to NMC, with x>y and x>z), or a lithium/nickel/cobalt/aluminum composite oxide having a high nickel content (LiNi_{x′}Co_{y′}Al_{z′} with x′+y′+z′=1, abbreviated to NCA, with x′>y′ and x′>z′).

Specific examples of these oxides are NMC532 (LiNi_{0.5}Mn_{0.3}Co_{0.2}O₂), NMC622 (LiNi_{0.6}Mn_{0.2}Co_{0.2}O₂) and NMC811 (LiNi_{0.8}Mn_{0.1}Co_{0.1}O₂).

The material of each electrode can also comprise, besides the electrochemically active material, an electronically conductive material, such as a carbon source, including, for example, carbon black, Ketjen® carbon, Shawinigan carbon, graphite, graphene, carbon nanotubes, carbon fibers (for example, vapor-grown carbon fibers or VGCFs), non-powdery carbon obtained by carbonization of an organic precursor, or a combination of two or more of these. Other additives can also be present in the material of the positive electrode, such as lithium salts or inorganic particles of ceramic or glass type, or also other compatible active materials (for example sulfur).

The material of each electrode may also comprise a binder. Nonlimiting examples of binders comprise linear, branched and/or crosslinked polyether polymer binders (for example polymers based on poly(ethylene oxide) (PEO), or poly(propylene oxide) (PPO) or on a mixture of the two (or an EO/PO copolymer), and optionally comprising crosslinkable units), water-soluble binders (such as SBR (styrene/butadiene rubber), NBR (acrylonitrile/butadiene rubber), HNBR (hydrogenated NBR), CHR (epichlorohydrin rubber), ACM (acrylate rubber)), or binders of fluoropolymer type (such as PVDF (polyvinylidene fluoride), PTFE (polytetrafluoroethylene)), and combinations thereof. Some binders, such as those which are soluble in water, can also comprise an additive, such as CMC (carboxymethylcellulose).

The separator can be a porous polymer film. By way of nonlimiting example, the separator can consist of a porous film of polyolefin, such as ethylene homopolymers, propylene homopolymers, ethylene/butene copolymers, ethylene/hexene copolymers, ethylene/methacrylate copolymers or multilayer structures of the above polymers.

The electrolyte comprises at least one lithium salt and preferably comprises a plurality of lithium salts.

In the context of the invention, the lithium salt comprises lithium bis(fluorosulfonyl)imide (LiFSI).

In certain embodiments, the lithium salt essentially consists, or even consists, of lithium bis(fluorosulfonyl)imide (LiFSI).

According to other embodiments, the lithium salt comprises lithium bis(fluorosulfonyl)imide and also one or more additional salts selected from lithium 2-trifluoromethyl-4,5-dicyanoimidazolate de (LiTDI), lithium bis(trifluoromethanesulfonyl)imide (LiTFSI), lithium bis(oxalato)borate (LiBOB), lithium difluoro(oxalato)borate (LiDBOB), lithium difluorophosphate (LiPO₂F₂), and lithium tetrafluoroborate (LiBF₄).

The electrolyte solvent can be chosen from ethers, esters, ketones, alcohols, nitriles, carbonates, amides, sulfamides and sulfonamides, and mixtures thereof. Preferably, the electrolyte solvent comprises at least one solvent selected from carbonates, ethers and nitriles, and more preferably the electrolyte solvent comprises at least one carbonate.

Among the ethers, mention may be made of linear or cyclic ethers, for instance dimethoxyethane (DME), methyl ethers of oligoethylene glycols containing 2 to 5 oxyethylene units, dioxolane, dioxane, dibutyl ether, tetrahydrofuran, and mixtures thereof.

Mention may be made, among the esters, of phosphoric acid esters or sulfite esters. Mention may be made, for example, of methyl formate, methyl acetate, methyl propionate, ethyl acetate, butyl acetate, γ-butyrolactone or mixtures thereof.

Among the ketones, mention may notably be made of cyclohexanone.

Mention may be made, among the alcohols, for example, of ethyl alcohol or isopropyl alcohol.

Among the nitriles, examples that may be mentioned include pyruvonitrile, propionitrile, methoxypropionitrile, acetonitrile, dimethylaminopropionitrile, butyronitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile, 1,2,6-tricyanohexane, and mixtures thereof.

Mention may be made, among the carbonates, for example, of cyclic carbonates, such as, for example, ethylene carbonate (EC) (CAS: 96-49-1), propylene carbonate (PC) (CAS: 108-32-7), butylene carbonate (BC) (CAS: 4437-85-8), dimethyl carbonate (DMC) (CAS: 616-38-6), diethyl carbonate (DEC) (CAS: 105-58-8), ethyl methyl carbonate (EMC) (CAS: 623-53-0), diphenyl carbonate (CAS: 102-09-0), methyl phenyl carbonate (CAS: 13509-27-8), dipropyl carbonate (DPC) (CAS: 623-96-1), methyl propyl carbonate (MPC) (CAS: 1333-41-1), ethyl propyl carbonate (EPC), vinylene carbonate (VC) (CAS: 872-36-6), fluoroethylene carbonate (FEC) (CAS: 114435 -02-8), trifluoropropylene carbonate (CAS: 167951-80-6) or mixtures thereof.

Among the amides, mention may be made of dimethylformamide and N-methylpyrrolidinone.

More preferably, the electrolyte solvent is selected from EC, EMC, mixtures of EC and EMC, mixtures of EC and DMC, mixtures of EC and DEC, mixtures of EC and DEC, PC, mixtures of EC, DMC and EMC.

Optionally, the electrolyte can comprise one or more polar polymers. The polar polymer preferably comprises monomer units derived from ethylene oxide, propylene oxide, epichlorohydrin, epifluorohydrin, trifluoroepoxypropane, acrylonitrile, methacrylonitrile, esters and amides of acrylic and methacrylic acid, vinylidene fluoride, N-methylpyrrolidone and/or polycation or polyanion polyelectrolytes. When the present electrolytic composition comprises more than one polymer, at least one of them may be crosslinked.

Furthermore, the electrolyte may comprise one or more additives. The additive(s) may be selected from the group consisting of fluoroethylene carbonate (FEC), vinylene carbonate, 4-vinyl-1,3-dioxolan-2-one, pyridazine, vinylpyridazine, quinoline, vinylquinoline, butadiene, sebaconitrile, alkyl disulfides, fluorotoluene, 1,4-dimethoxytetrafluorotoluene, t-butylphenol, di(t-butyl)phenol, tris(pentafluorophenyl)borane, oximes, aliphatic epoxides, halogenated biphenyls, methacrylic acids, allyl ethyl carbonate, vinyl acetate, divinyl adipate, propane sultone, acrylonitrile, 2-vinylpyridine, maleic anhydride, methyl cinnamate, phosphonates, silane compounds containing a vinyl, and/or 2-cyanofuran.

The at least one lithium salt may be present in the electrolyte in a content of from 0.1% to 50% relative to the weight of the electrolyte.

### Process

The process according to the invention makes it possible to prepare a lithium bis(fluorosulfonyl)imide solution having a low water content and being able to be used as Li-ion battery electrolyte either directly or after addition of salts, solvents and/or additives.

The process according to the invention comprises a step of contacting of the bis(fluorosulfonyl)imide with a lithium base in a solvent in order to form a mixture comprising the lithium bis(fluorosulfonyl)imide and water.

The bis(fluorosulfonyl)imide used in this step may be obtained from a sulfonamide of the following formula (I) by a chlorination step:

R—(SO₂)—NH₂ (I)
in which R may be chosen from a fluorine atom, a chlorine atom or a hydroxy group.

This step can be effected with at least one sulfur-based acid and at least one chlorinating agent.

In addition, this step can be carried out:
at a temperature of between 30° C. and 150° C.; and/or
with a reaction time of between 1 hour and 7 days; and/or
at a pressure of between 1 bar abs and 20 bar abs.

According to the invention, the sulfur-based agent may be selected from the group consisting of chlorosulfonic acid (ClSO₃H), sulfuric acid, oleum, and mixtures thereof.

According to the invention, the chlorinating agent may be selected from the group consisting of thionyl chloride (SOCl₂), oxalyl chloride (COCl)₂, phosphorus pentachloride (PCl₅), phosphonyl trichloride (PCl₃), phosphoryl trichloride (POCl₃), and mixtures thereof. Preferably, the chlorinating agent is thionyl chloride.

The chlorination step can be performed in the presence of a catalyst, for instance selected from a tertiary amine (such as methylamine, triethylamine or diethylmethylamine); pyridine; and 2,6-lutidine.

The molar ratio between the sulfur-based acid and the compound of formula (I) can be between 0.7 and 5, preferably between 0.9 and 5.

The molar ratio between the chlorinating agent and the compound of formula (I) can be between 2 and 10, preferably between 2 and 5.

In particular, when the sulfur-based agent is chlorosulfonic acid, the molar ratio between the latter and the compound of formula (I) is between 0.9 and 5, and/or the molar ratio between the chlorinating agent and the compound of formula (I) is between 2 and 5.

In particular, when the sulfur-based agent is sulfuric acid (or oleum), the molar ratio between the sulfuric acid (or oleum) and the compound of formula (I) is between 0.7 and 5.

In particular, when the sulfur-based agent is sulfuric acid (or oleum), the molar ratio between the sulfuric acid (or oleum) and the compound of formula (I) is between 0.9 and 5, and/or the molar ratio between the chlorinating agent and the compound of formula (I) is between 2 and 10.

The chlorination step advantageously makes it possible to form a compound of formula (II):

R—(SO₂)—NH—(SO₂)—Cl (II)

The process according to the invention may then comprise a step of fluorinating the compound of formula (II).

The fluorination of this compound of formula (I) can be effected with at least one fluorinating agent and preferably in the presence of at least one organic solvent SO1.

According to one embodiment, the fluorinating agent is selected from the group consisting of HF (preferably anhydrous HF), KF, AsF₃, BiF₃, ZnF₂, SnF₂, PbF₂, CuF₂, and mixtures thereof, the fluorinating agent preferably being HF, and even more preferentially anhydrous HF.

In the context of the invention, the term “anhydrous HF” is understood to mean HF containing less than 500 ppm of water, with preference less than 300 ppm of water, preferably less than 200 ppm of water.

The fluorination step is preferably carried out in at least one organic solvent SO1. The organic solvent SO1 preferably has a donor number of between 1 and 70, and advantageously of between 5 and 65. The donor number of a solvent represents the value −ΔH, ΔH being the enthalpy of the interaction between the solvent and antimony pentachloride (according to the method described in Journal of Solution Chemistry, vol. 13, No. 9, 1984). As organic solvent SO1, mention may in particular be made of esters, nitriles, dinitriles, ethers, diethers, amines, phosphines, and mixtures thereof.

Preferably, the organic solvent SO1 is selected from the group consisting of methyl acetate, ethyl acetate, butyl acetate, acetonitrile, propionitrile, isobutyronitrile, glutaronitrile, dioxane, tetrahydrofuran, triethylamine, tripropylamine, diethylisopropylamine, pyridine, trimethylphosphine, triethylphosphine, diethylisopropylphosphine, and mixtures thereof. In particular, the organic solvent SO1 is dioxane.

The fluorination step can be implemented at a temperature of between 0° C. and the boiling point of the organic solvent SO1 (or of the mixture of organic solvents SO1). Preferably, the fluorination step is carried out at a temperature of between 5° C. and the boiling point of the organic solvent SO1 (or of the mixture of organic solvents SO1), preferentially between 20° C. and the boiling point of the organic solvent SO1 (or of the mixture of organic solvents SO1).

The step of fluorination, preferably with anhydrous fluorohydric acid, can be implemented at a pressure P, preferably of between 0 and 16 bar abs.

This fluorination step is preferably implemented by dissolving the compound of formula (II) in the organic solvent SO1, or the mixture of organic solvents SO1, prior to the step of reaction with the fluorinating agent, preferably with anhydrous HF.

The mass ratio between the compound of formula (II) and the organic solvent SO1, or the mixture of organic solvents SO1, is preferably between 0.001 and 10, and advantageously between 0.005 and 5.

According to one embodiment, anhydrous HF is introduced into the reaction medium, preferably in gaseous form.

The molar ratio between the fluorinating agent, preferably anhydrous HF, and the compound of formula (II) employed is preferably between 1 and 10, and advantageously between 1 and 5.

The step of reaction with the fluorinating agent, preferably anhydrous HF, can be effected in a closed medium or an open medium; preferably, the fluorination step is effected in an open medium with in particular the evolution of HCl in gas form.

The fluorination reaction typically leads to the formation of HCl, the majority of which may be degassed from the reaction medium (just like the excess HF if the fluorinating agent is HF), for example by entrainment (stripping) with a neutral gas (such as nitrogen, helium or argon).

However, residual HF and/or HCl may be dissolved in the reaction medium. In the case of HCl, the amounts are very low since, at the working pressures and temperature, HCl is mainly in gas form.

The composition obtained on conclusion of the fluorination step can be stored in an HF-resistant container.

The composition obtained in the fluorination step may comprise HF (it is in particular unreacted HF), the bis(fluorosulfonyl)imide, the solvent SO1 (for instance dioxane), and optionally HCl, and/or optionally heavy compounds.

The process according to the invention can preferably comprise a step of distillation of the solution obtained after the fluorination step.

According to one embodiment, the distillation step makes it possible to form and to recover:
a first stream F1 comprising HF, optionally the organic solvent SO1 and/or optionally HCl, preferably at the top of the distillation column, said stream F1 being gaseous or liquid;
a second stream F2 comprising the bis(fluorosulfonyl)imide, and optionally heavy compounds, preferably at the bottom of the distillation column, said stream F2 preferably being liquid.

When stream F2 comprises heavy compounds, it may be subjected to an additional distillation step in a second distillation column, to form and to recover:
a stream F2-1 comprising the bis(fluorosulfonyl)imide, devoid of heavy compounds, preferably at the top of the distillation column, said stream F2-1 preferably being liquid,
a stream F2-2 comprising the heavy compounds and the bis(fluorosulfonyl)imide, preferably at the bottom of the distillation column, said stream F2-2 containing less than 10% by weight of the bis(fluorosulfonyl)imide contained in the composition obtained after the fluorination step, preferably less than 7% by weight, and preferentially less than 5% by weight, said stream F2-2 preferably being liquid.

According to one embodiment, the step of distillation of the composition obtained in the fluorination step makes it possible to form and to recover, by virtue of the use of two distillation columns:
a first stream F1 comprising HF, optionally the organic solvent SO1 and/or optionally HCl at the top of the first distillation column, said stream F1 being gaseous or liquid;
a second stream F2 comprising the bis(fluorosulfonyl)imide, and optionally heavy compounds, at the bottom of the first distillation column, said stream F2 preferably being liquid;
said stream F2 being subjected to a distillation step in a second distillation column, to form and to recover:
a stream F2-1 comprising the bis(fluorosulfonyl)imide, devoid of heavy compounds, at the top of the second distillation column, said stream F2-1 preferably being liquid,
a stream F2-2 comprising the heavy compounds and the bis(fluorosulfonyl)imide, at the bottom of the second distillation column, said stream F2-2 containing less than 10% by weight of the bis(fluorosulfonyl)imide contained in the composition obtained after the fluorination step, preferably less than 7% by weight, and preferentially less than 5% by weight, said stream F2-2 preferably being liquid.

In the context of the invention, the term “heavy compounds” is understood to mean organic compounds having a boiling point greater than that of the bis(fluorosulfonyl)imide. They may result from cleavage reactions of the compound of formula (II), leading, for example, to compounds such as FSO₂NH₂, and/or from solvent degradation reactions, leading to the formation of oligomers.

According to one embodiment, the step of distillation of the composition obtained in the fluorination step makes it possible to form and to recover:
a first stream F′1 comprising HF, optionally the organic solvent SO1 and/or optionally HCl, preferably at the top of the distillation column, said stream F′1 being gaseous or liquid;
a second stream F′2 comprising the bis(fluorosulfonyl)imide, preferably recovered by sidestream withdrawal, said stream F′2 preferably being liquid;
a third stream F′3 comprising the heavies and the bis(fluorosulfonyl)imide, preferably at the bottom of the distillation column, said stream F′3 containing less than 10% by weight of the bis(fluorosulfonyl)imide contained in the composition obtained in the fluorination step, preferably less than 7% by weight, and preferentially less than 5% by weight, said stream F′3 preferably being liquid.

To effect the sidestream withdrawal, the distillation column may contain at least one tray.

The distillation step can be effected at a pressure ranging from 0 to 5 bar abs, preferably from 0 to 3 bar abs, preferentially from 0 to 2 bar abs, and advantageously from 0 to 1 bar abs.

The distillation step can be effected:
at a distillation column bottom temperature ranging from 150° C. to 200° C., preferably from 160° C. to 180° C., and preferentially from 165° C. to 175° C., at a pressure of 1 bar abs; or
at a distillation column bottom temperature ranging from 30° C. to 100° C., preferably from 40° C. to 90° C., and preferentially from 40° C. to 85° C., at a pressure of 0.03 bar abs.

The distillation step can be effected in any conventional apparatus. Such an apparatus may be a distillation apparatus comprising a distillation column, a boiler and a condenser.

The distillation column can comprise:
at least one packing, for instance a random packing and/or a structured packing, and/or
trays, for instance perforated trays, fixed valve trays, movable valve trays, bubble cap trays or combinations thereof.

The height of the distillation column typically depends on the nature of the compounds to be separated. Typically, depending on the flow rates used, the distillation column may have any type of diameter: small (less than or equal to 1 meter) or high (greater than 1 meter).

The material of the distillation column, of its internal constituents (packing and/or trays), of the boiler and/or of the condenser is advantageously selected from corrosion-resistant materials, on account of the potential presence of HF and/or HCl in the composition subjected to distillation.

The corrosion-resistant materials may be selected from enamelled steels, nickel, titanium, chromium, graphite, silicon carbides, nickel-based alloys, cobalt-based alloys, chromium-based alloys, steels partially or totally coated with a protective fluoropolymer coating (for instance PVDF: polyvinylidene fluoride, PTFE: polytetrafluoroethylene, PFA: copolymer of C₂F₄ and of perfluorinated vinyl ether, FEP: copolymer of C₂F₄ and of C₃F₆, ETFE: copolymer of ethylene and of tetrafluoroethylene, or FKM: copolymer of hexafluoropropylene and of difluoroethylene).

The nickel-based alloys are preferably alloys comprising at least 40% by weight of nickel, preferably at least 50% by weight of nickel, relative to the total weight of the alloy. Examples that may be mentioned include the alloys Inconel®, Hastelloy® or Monel®.

The streams F1 and F′1 may comprise HF, HCl and the organic solvent SO1 (in particular dioxane).

According to one embodiment, stream F1 comprises from 2% to 70% by weight of HF, preferably from 5% to 60% by weight of HF, relative to the total weight of stream F1, and from 30% to 98% by weight of organic solvent SO1, preferably from 40% to 95% by weight of SO1, relative to the total weight of stream F1.

According to one embodiment, stream F′1 comprises from 2% to 70% by weight of HF, preferably from 5% to 60% by weight of HF, relative to the total weight of stream F′1, and from 30% to 98% by weight of organic solvent SO1, preferably from 40% to 95% by weight of SO1, relative to the total weight of stream F′1.

According to one embodiment, stream F2 comprises from 50% to 100% by weight of bis(fluorosulfonyl)imide, preferably from 70% to 99% by weight of bis(fluorosulfonyl)imide, relative to the total weight of stream F2.

According to one embodiment, stream F′2 comprises from 50% to 100% by weight of bis(fluorosulfonyl)imide, preferably from 70% to 99% by weight of bis(fluorosulfonyl)imide, relative to the total weight of stream F′2.

According to one embodiment, stream F2-1 comprises from 50% to 100% by weight of bis(fluorosulfonyl)imide, preferably from 70% to 99% by weight of bis(fluorosulfonyl)imide, relative to the total weight of stream F2-1.

Thus, the stream comprising the bis(fluorosulfonyl)imide (or the solution resulting from the fluorination step), for example one of streams F2, F′2 and/or F2-1 described above, is contacted with a lithium base.

The lithium base may comprise at least one lithium atom and at least one oxygen atom. Thus, this base is capable of generating water after reaction thereof with the bis(fluorosulfonyl)imide. This base can for example comprise or be selected from lithium hydroxide (LiOH), lithium carbonate (Li₂CO₃), and mixtures thereof.

Preferably, the lithium base does not comprise lithium fluoride.

The molar ratio of the lithium base to the bis(fluorosulfonyl)imide can be from 0.9 to 1.1 and preferably from 1 to 1.05.

This contacting is effected in a solvent. The solvent is selected from carbonates, ethers and nitriles.

Among the ethers, mention may be made of linear or cyclic ethers, for instance dimethoxyethane (DME), methyl ethers of oligoethylene glycols containing 2 to 5 oxyethylene units, dioxolane, dioxane, dibutyl ether, tetrahydrofuran, and mixtures thereof.

Among the nitriles, examples that may be mentioned include acetonitrile, pyruvonitrile, propionitrile, methoxypropionitrile, dimethylaminopropionitrile, butyronitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile, 1,2,6-tricyanohexane, and mixtures thereof. A preferred nitrile is acetonitrile.

Mention may be made, among the carbonates, for example, of cyclic carbonates, such as, for example, ethylene carbonate, propylene carbonate, butylene carbonate, dimethyl carbonate, diethyl carbonate, ethyl methyl carbonate, diphenyl carbonate, methyl phenyl carbonate, dipropyl carbonate, methyl propyl carbonate, ethyl propyl carbonate, vinylene carbonate, fluoroethylene carbonate, trifluoropropylene carbonate or mixtures thereof.

Preferably, the solvent used for the contacting of the lithium base with the bis(fluorosulfonyl)imide is a carbonate, and more preferably dimethyl carbonate.

The mass ratio of bis(fluorosulfonyl)imide to solvent can be from 10% to 60%, preferably from 30% to 40%.

This step can be effected by adding the bis(fluorosulfonyl)imide and the lithium base to the solvent. For example, the bis(fluorosulfonyl)imide can be added to a dispersion of the lithium base in the solvent.

In addition, the step of contacting can be effected at a temperature from 0 to 50° C.

Thus, this step makes it possible to obtain a mixture comprising the lithium bis(fluorosulfonyl)imide and water. This mixture can have a water content of equal to or greater than 2%, preferably equal to or greater than 3%, preferably equal to or greater than 4%, relative to the weight of the mixture.

This mixture may also comprise one or more impurities. These impurities can comprise, for example, lithium fluoride (LiF), lithium sulfate (Li₂SO₄), and/or lithium chloride (LiCl).

A filtration step may optionally be carried out after the contacting step.

According to certain embodiments, the process according to the invention comprises a step of pervaporation of the mixture obtained above. This step makes it possible to reduce the content of water in the mixture. Thus, at the end of this step, the mixture comprising the lithium bis(fluorosulfonyl)imide may have a water content of less than or equal to 500 ppm, and preferably less than or equal to 400 ppm, relative to the weight of the mixture. For example, this content may be from 100 to 150 ppm; or from 150 to 200 ppm; or from 200 to 250 ppm; or from 250 to 300 ppm; or from 300 to 350 ppm; or from 350 to 400 ppm; or from 400 to 450 ppm; or from 450 to 500 ppm, relative to the weight of the mixture.

In addition or alternatively, the process according to the invention can comprise a step of azeotropic distillation of the mixture obtained above. This distillation can for example be effected by evaporation (batch evaporation, or falling-film evaporation, or wiped-film evaporation) or in the presence of a distillation column, preferably at a pressure of between 0.01 and 1013 mbar and at a temperature preferably of less than 100° C., and more preferably less than 50° C. This step also makes it possible to reduce the content of water in the mixture. Thus, at the end of this step, the mixture comprising the lithium bis(fluorosulfonyl)imide may have a water content of less than or equal to 500 ppm, and preferably less than or equal to 400 ppm, relative to the weight of the mixture. For example, this content may be from 100 to 150 ppm; or from 150 to 200 ppm; or from 200 to 250 ppm; or from 250 to 300 ppm; or from 300 to 350 ppm; or from 350 to 400 ppm; or from 400 to 450 ppm; or from 450 to 500 ppm, relative to the weight of the mixture.

Alternatively or in addition to one of the steps described above, the process according to the invention comprises a step of diafiltration of the mixture. The term “mixture” is understood here to mean either the mixture obtained after the step of contacting of the lithium base with the bis(fluorosulfonyl)imide, or the mixture obtained after the pervaporation step, or the mixture obtained after the azeotropic distillation step.

The diafiltration is effected on a nanofiltration membrane.

According to certain embodiments, the nanofiltration membrane can have a cutoff threshold of 80 to 250 dalton, preferably 100 to 200 dalton, and more preferably 120 to 180 dalton.

The presence of the nanofiltration membrane on the one hand makes it possible to retain the lithium bis(fluorosulfonyl)imide and on the other hand to allow the water, the solvent and the various impurities to pass. Thus, obtained at the end of this step are, firstly, a concentrate enriched in lithium bis(fluorosulfonyl)imide and depleted in water (and in impurities) and, secondly, a permeate depleted in lithium bis(fluorosulfonyl)imide and enriched in water (and in impurities).

According to certain embodiments, the diafiltration step is effected at a pressure from 1 to 60 bar.

According to certain embodiments, the diafiltration step is effected at a temperature from 5 to 60° C.

Preferentially, during the diafiltration step, solvent can be added to the concentrate. Thus, preferably, the content of lithium bis(fluorosulfonyl)imide in the concentrate is essentially equal to the content of lithium bis(fluorosulfonyl)imide in the mixture entering the diafiltration. Preferably, this solvent is the same as the solvent used in the step of contacting of the bis(fluorosulfonyl)imide with the lithium base. Alternatively, this solvent is different from the solvent used in the step of contacting of the bis(fluorosulfonyl)imide with the lithium base. In this case, the solvent can be selected from carbonates, ethers and nitriles as detailed above. Preferably, the solvent added is devoid of water or comprises a content of water of less than or equal to 50 ppm, or less than or equal to 20 ppm, for example. Alternatively, solvent can be added to the mixture before the diafiltration step in order to effect a dilution. In this case, the concentrate may then be concentrated in order to remove some of the solvent.

During the diafiltration step, the amount of solvent used can be from 1 to 20 times the volume of the mixture obtained after the step of contacting of the lithium base with the bis(fluorosulfonyl)imide. More particularly, in the case where the process comprises a step of pervaporation or of azeotropic distillation (before the diafiltration step), the amount of solvent used during the diafiltration step can be from 1 to 10 times, and preferably from 2 to 3 times, the volume of the mixture obtained after the step of contacting of the lithium base with the bis(fluorosulfonyl)imide. On the other hand, in the case where the process does not include a step of pervaporation or of azeotropic distillation, the amount of solvent used during the diafiltration step can be from 5 to 20 times, and preferably from 6 to 8 times, the volume of the mixture obtained after the step of contacting of the lithium base with the bis(fluorosulfonyl)imide.

According to certain preferred embodiments, the concentrate obtained after the diafiltration step comprises a content of water of equal to or less than 100 ppm, preferably equal to or less than 50 ppm, and more preferably equal to or less than 20 ppm, relative to the weight of the concentrate. This content may for example be from 1 to 10 ppm; or from 10 to 20 ppm; or from 20 to 30 ppm; or from 30 to 40 ppm; or from 40 to 50 ppm; or from 50 to 60 ppm; or from 60 to 70 ppm; or from 70 to 80 ppm; or from 80 to 90 ppm; or from 90 to 100 ppm, relative to the weight of the concentrate.

In addition, the concentrate obtained after the diafiltration step can comprise a content of impurities of equal to or less than 100 ppm lithium fluoride, and/or equal to or less than 10 ppm lithium chloride, and/or equal to or less than 50 ppm lithium sulfate.

Thus, the concentrate can have a content of lithium bis(fluorosulfonyl)imide of 10% to 60% by weight, and preferably of 30% to 40% by weight.

### Use

The present invention also relates to the use of the lithium bis(fluorosulfonyl)imide obtained by the process according to the invention, in Li-ion batteries as described above, in particular in Li-ion battery electrolytes.

In particular, such batteries are Li-ion batteries of mobile devices (for example cellphones, cameras, tablets or laptop computers), or of electric vehicles, or for storing renewable energy (such as photovoltaic or wind energy).

According to certain embodiments, the concentrate obtained after the diafiltration step can be directly used as Li-ion battery electrolyte.

According to other preferred embodiments, the concentrate obtained after the diafiltration step can be used as Li-ion battery electrolyte after the addition of one or more components such as additional lithium salts, additional solvents and/or additives. These components are as detailed above.

1. A process for preparing lithium bis(fluorosulfonyl)imide, comprising the following steps of:
contacting of bis(fluorosulfonyl)imide with a lithium base in a solvent selected from carbonates, ethers and nitriles, to obtain a mixture comprising lithium bis(fluorosulfonyl)imide and water;
diafiltration of the mixture on a nanofiltration membrane so as to obtain, firstly, a concentrate enriched in lithium bis(fluorosulfonyl)imide and depleted in water and, secondly, a permeate depleted in lithium bis(fluorosulfonyl)imide and enriched in water.

2. The process as claimed in claim 1, wherein the solvent is a carbonate, preferably selected from dimethyl carbonate, methyl ethyl carbonate, diethyl carbonate, ethylene carbonate, propylene carbonate, butylene carbonate, diphenyl carbonate, methyl phenyl carbonate, dipropyl carbonate, methyl propyl carbonate, ethyl propyl carbonate, vinylene carbonate, fluoroethylene carbonate, trifluoropropylene carbonate, or mixtures thereof.

3. The process as claimed in claim 1, wherein the lithium base is selected from lithium hydroxide, lithium carbonate, and mixtures thereof.

4. The process as claimed in claim 1, wherein the nanofiltration membrane has a cutoff threshold of 80 to 250 dalton, preferably 100 to 200 dalton, and more preferably 120 to 180 dalton.

5. The process as claimed in claim 1, comprising a step of pervaporation between the step of contacting bis(fluorosulfonyl)imide with a lithium base and the diafiltration step.

6. The process as claimed in claim 1, comprising a step of azeotropic distillation between the step of contacting bis(fluorosulfonyl)imide with a lithium base and the diafiltration step.

7. The process as claimed in claim 1, wherein the concentrate enriched in lithium bis(fluorosulfonyl)imide and depleted in water comprises a content of water of equal to or less than 100 ppm, preferably equal to or less than 50 ppm, and more preferably equal to or less than 20 ppm, relative to the weight of the concentrate.

8. The process as claimed in claim 1, wherein solvent is added during the diafiltration step to the concentrate, the solvent preferably being the same as the solvent used in the step of contacting bis(fluorosulfonyl)imide with a lithium base.

9. The process as claimed in claim 1, wherein the diafiltration step is effected at a pressure from 1 to 60 bar.

10. A process for preparing an Li-ion battery electrolyte, comprising:
preparing lithium bis(fluorosulfonyl)imide as claimed in claim 1;
preparing an electrolyte comprising lithium bis(fluorosulfonyl)imide.
